(19) United States
(12) Patent Application Publication
(10) Pub. No.: US 2025/0078603 A1
(43) Pub. Date: Mar. 6, 2025

(54) SURFACE INTEGRATED SPEAKERS IN ELECTRONIC GAMING MACHINE

(71) Applicant: IGT, Las Vegas, NV (US)

(72) Inventors: Michael RUSS, Graz (AT); Soheil LATIFI, Brampton (CA); Sven AURICH; Stefan KEILWERT, St. Josef (AT)

(73) Assignee: IGT, Las Vegas, NV (US)

(21) Appl. No.: 18/462,329

(22) Filed: Sep. 6, 2023

(51) Int. Cl. G07F 17/32

(52) U.S. Cl. CPC G07F 17/3206; G07F 17/3216; G07F 17/3225

(57) ABSTRACT

An electronic gaming machine (“EGM”) can include a surface-integrated speaker, a processor circuit coupled to the surface-integrated speaker, and a memory coupled to the processor circuit. The memory can include machine-readable instructions that, when executed by the processor circuit, cause the EGM to perform operations. The operations can include determining a position on the EGM from which to output audio. The operations can further include outputting, via a surface-integrated speaker, the audio at the position.

### BACKGROUND

Embodiments described herein relate to electronic gaming machines (“EGMs”). EGMs can include one or more games (e.g., wagering games) stored therein that can be played by a player. The EGM can provide a prize to the player based on a wager and an outcome of a wagering game. An example of a wagering game includes a slot game in which, in response to receiving a wager from the player, one or more rows of symbols are revealed. A prize can be provided to the player based on the one or more rows of symbols including one or more winning combinations of symbols.

### SUMMARY

According to some embodiments a method of operating an electronic gaming machine (“EGM”) that includes a surface-integrated speaker is provided. The method includes determining a position on the EGM from which to output audio. The method further includes outputting, via the surface-integrated speaker, the audio at the position.

According to other embodiments, a method of operating an EGM that includes a surface-integrated speaker is provided. The method includes determining a virtual location of a virtual element associated with operation of the EGM. The method further includes determining an auditory output associated with the virtual element. The method further includes determining a position on the EGM corresponding to the auditory output associated with the virtual element based on the virtual location. The method further includes outputting true three-dimensional (“3D”) audio of the auditory output via a surface-integrated speaker at the position on the EGM.

According to other embodiments, a method of operating audio in a casino environment is provided. The method includes determining a position of a person in a casino environment. The method further includes determining a surface-integrated speaker to output audio to the person based on a position of the person and a position of the surface-integrated speaker. The method further includes outputting the audio via the surface-integrated speaker.

According to other embodiments, an EGM, a system, or non-transitory computer-readable medium are provided for performing the above methods.

### BRIEF DESCRIPTION OF THE DRAWINGS

FIG. 1 is a schematic block diagram illustrating an example of a network configuration for a plurality of gaming devices according to some embodiments;

FIGS. 2A-E are diagrams illustrating examples of gaming devices according to some embodiments;

FIGS. 3-4 are schematic diagrams illustrating examples of a display of an EGM that includes a surface-integrated speaker according to some embodiments;

FIGS. 5-6 are schematic diagrams illustrating examples of a button of an EGM that includes a surface-integrated speaker according to some embodiments;

FIG. 7 is a schematic diagram illustrating an example of an EGM with a surface-integrated speaker according to some embodiments;

FIGS. 8A-D are schematic diagrams illustrating examples of a display of an EGM with a surface-integrated speaker according to some embodiments;

FIGS. 9-10 are flow charts illustrating examples of operations performed by an EGM according to some embodiments; and

FIG. 11 is a flow chart illustrating an example of operations to control audio in a casino environment according to some embodiments.

### DETAILED DESCRIPTION

Electronic gaming machines (“EGMs”) can include a gaming cabinet with a limited amount of space to house its components. This space limitation can be a deciding factor in what components are included (and where they are placed) within an EGM, which can limit what features can be provide by the EGM in association with a game. In some examples, the space limitation is based on a desire to keep the footprint of an EGM as small as possible in order to fit more EGMs within a defined space (e.g., a casino floor).

Traditional speakers can require a significant amount of space. In some examples, an EGM may only include stereo speakers due to space limitations. In other examples, an EGM may include enough speakers to generate simulated three-dimensional (“3D”) sound (also sometimes referred to as surround sound). However, the space limitations of an EGM prevent the EGM from generating true 3D sound. Moreover, other components in an EGM (e.g., a display device or a button) occupy positions in the EGM that prevent the EGM from producing sound from those positions.

Various embodiments herein describe an EGM using a surface-integrated speaker. The surface-integrated speaker can be integrated into any surface of the EGM (e.g., a display surface or a surface of a button). In some examples, the EGM is able to provide true 3D sound including sound effects from specific positions (e.g., sound associated with a game element being produced from the position of the game element on a display surface). In additional or alternative examples, by using one or more surface-integrated speakers rather than traditional speakers the EGM has additional room for other components and/or can be produced with a smaller footprint.

In some embodiments, the surface-integrated speaker includes a lightweight (e.g., 40 g) passport sized (e.g., 150 mm×90 mm) sound source that can be produced without the use of rare earth elements (e.g., neodymium) that are commonly used in traditional speakers. In some examples, the surface-integrated speakers are integrated into a display surface.

These innovations can be used with various EGMs. In some examples, the EGM is a slot machine. In additional or alternative examples, the EGM is an electronic gaming table, kiosk, sports wagering terminal, or a video lottery terminal (“VLT”).

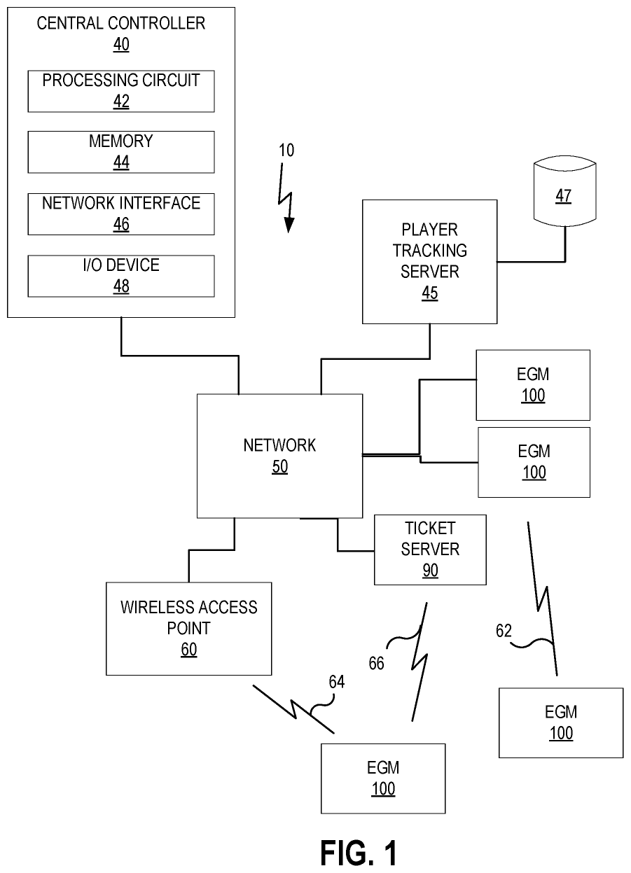

Before describing these and other embodiments in detail, reference is made to FIG. 1, which illustrates a gaming system 10 including a plurality of gaming devices 100. As discussed above, the gaming devices 100 may be one type of a variety of different types of gaming devices, such as electronic gaming machines (EGMs), mobile devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The central controller 40 can include processing circuit 42, memory 44, network interface 46, and an input/output (“I/O”) device 48. In some examples, the memory 44 includes instructions executable by processing circuit 42 for causing the central controller 40 to perform operations. The operations can include communicating with the data communication network 50 via the network interface 46 and/or communicating with a user/operator via the I/O device 48.

The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

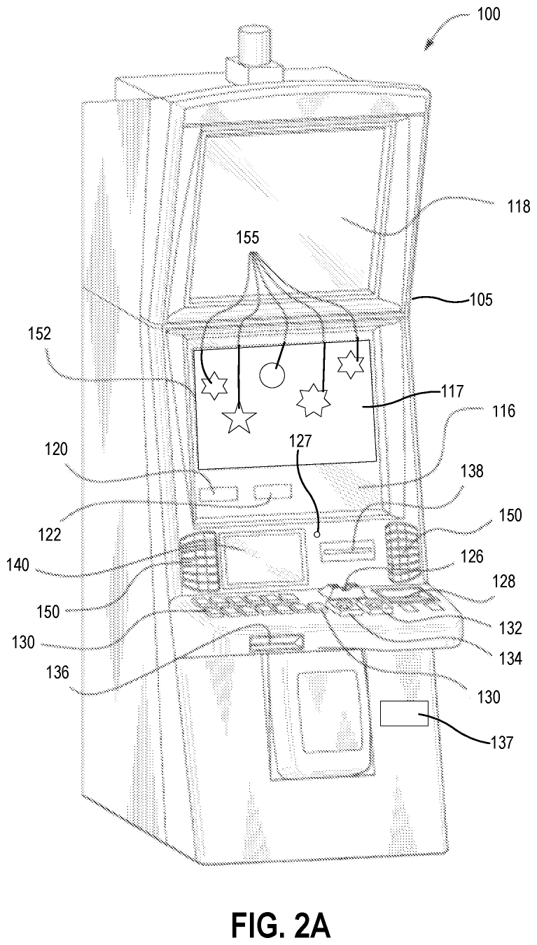

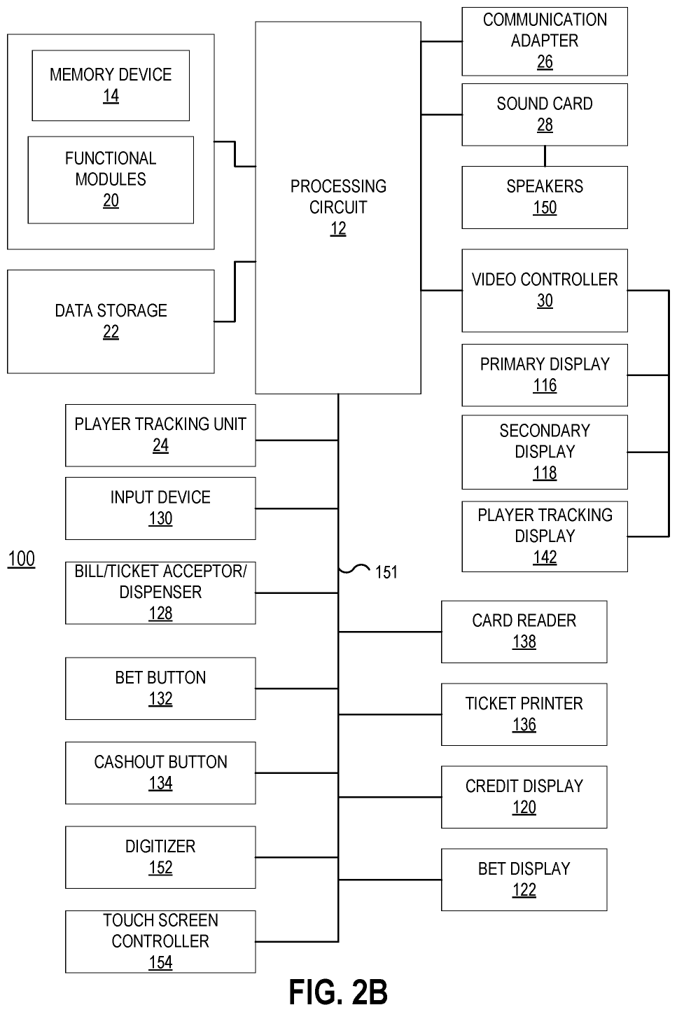

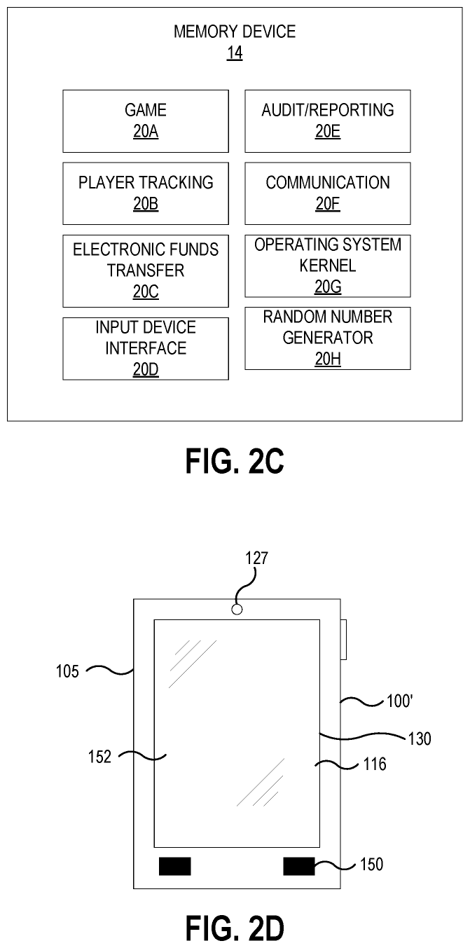

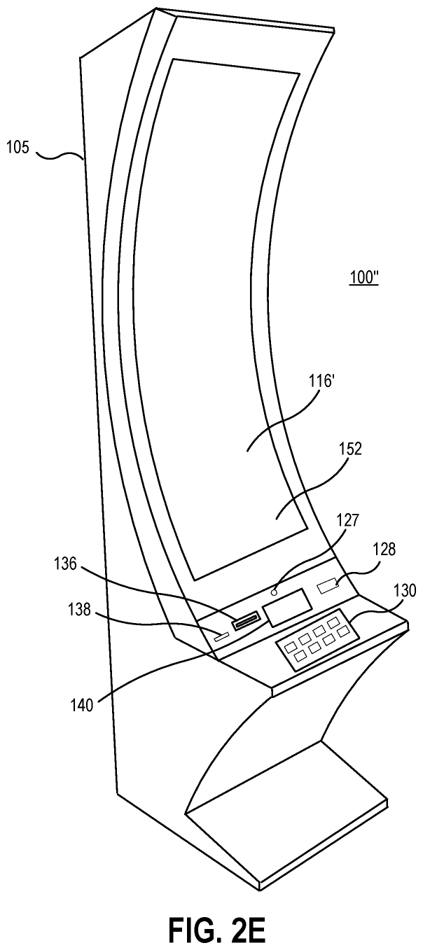

Embodiments herein may include different types of gaming devices. Various embodiments are illustrated in FIGS. 2A-2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A-C are provided as examples for illustrative purposes only. It will be appreciated that gaming devices may come in many different shapes, sizes, layouts, form factors, and configurations, and with varying numbers and types of input and output devices, and that embodiments of the inventive concepts are not limited to the particular gaming device structures described herein.

Gaming devices 100 typically include a number of standard features, many of which are illustrated in FIGS. 2A-B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30. The gaming device 100 may also include a player tracking unit 24 for managing communications and functionality between the processor circuit 12 and certain peripherals and components. Player tracking units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

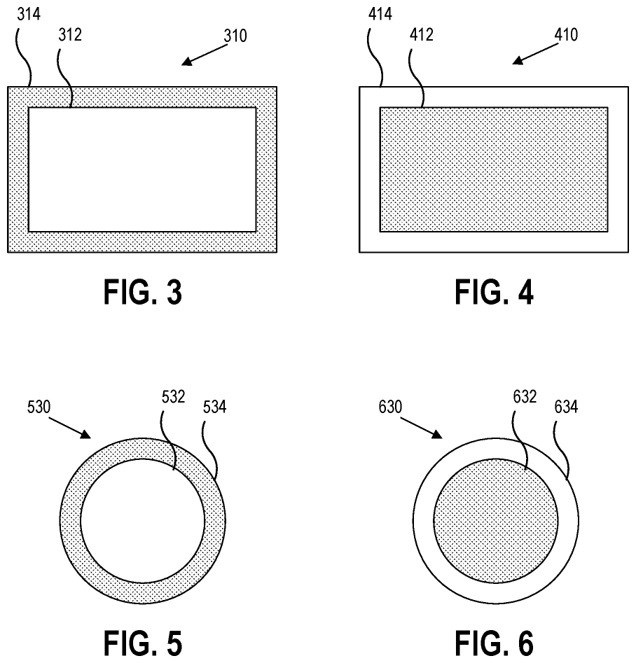

For example, referring to FIG. 2D, a gaming device 100′ may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits can be deposited in or transferred from the gaming device 100′ electronically.

FIG. 2E illustrates a standalone gaming device 100″, i.e., an EGM in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a player tracking display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGMs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Various embodiments herein describe an EGM using a surface-integrated speaker. The surface-integrated speaker can be integrated into any surface of the EGM (e.g., a display surface or a surface of a button). FIGS. 3-6 illustrate examples of surfaces of an EGM in which a surface-integrated speaker can be integrated. FIG. 3 illustrates an example of a display device 310 including a display surface 312 configured to display digital elements and an adjacent surface 314 (e.g., a surface surrounding, bordering, or within a threshold distance of the display surface 312) that includes a surface-integrated speaker. FIG. 4 illustrates an example of a display device 410 including a display surface 412 that includes a surface-integrated speaker (while still being configured to display digital elements) and an adjacent surface 414 (e.g., a surface surrounding, bordering, or within a threshold distance of the display surface 412).

FIG. 5 illustrates an example of a button 530 including a button surface 532 configured to detect input (e.g., touch) from a user and an adjacent surface 534 (e.g., a surface surrounding, bordering, or within a threshold distance of the button surface 532) that includes a surface-integrated speaker. FIG. 6 illustrates an example of a button 630 including a button surface 632 that includes a surface-integrated speaker (while still being configured to detect user input) and an adjacent surface 634 (e.g., surrounding, border, or within a threshold distance of the button surface 632).

In the examples of FIGS. 3-6, the surface 314, 412, 534, 632 that includes the surface-integrated speaker is shaded to indicate that it includes a surface-integrated speaker, however, in some examples the surface-integrated speaker may be invisible. In some examples, the surface-integrated speaker may include a plurality of surface-integrated speakers. In additional or alternative examples, an EGM can include surface-integrated speakers integrated into multiple surfaces (e.g., each of the surfaces 314, 412, 534, 632 illustrated in FIGS. 3-6). In additional or alternative examples, an EGM can include surface-integrated speakers integrated into other surface of the EGM (e.g., a surface of a seat or an armrest).

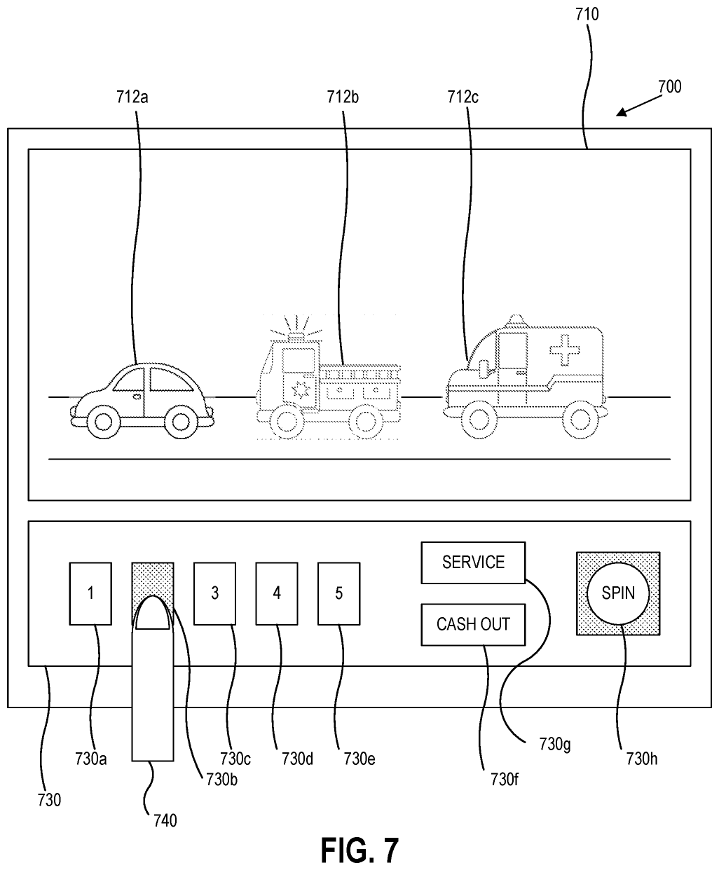

FIG. 7 illustrates an example of an EGM 700 with a display 710 and a physical button panel 730. In some embodiments, a surface-integrated speaker can be integrated into any surface of the EGM 700. In this example, the display 710 includes a plurality of invisible surface-integrated speakers that can be individually and simultaneously controlled. The display 710 is currently displaying three game elements 712a-c at three different positions and there is a surface-integrated speaker associated with each position.

The physical button panel 730 includes eight physical buttons 730a-h including five physical buttons 730a-e labeled 1-5 (the “2” being underneath a selector 740), a cash out button 730f, a service button 730g, and a spin button 730h. Some of these physical buttons 730a-f may be associated with game functions related to the game being displayed on the display 710. For example, the physical buttons 730a-c may each be associated with a game element 712a-c being displayed on the display 710. In this example, physical buttons 730b and 730h have a shaded portion representing surface-integrated speakers (physical button 730b illustrates the surface-integrated speaker as integrated into a button surface as illustrated in FIG. 5 and physical button 730h illustrates the surface-integrated speaker as integrated into an adjacent surface as illustrated in FIG. 6). The other buttons may include one or more surface-integrated speakers and/or the surface-integrated speakers integrated into physical buttons 730b and 730h may be invisible.

In some embodiments, the EGM 700 can provide true 3D sound by outputting sound at a specific position of one of the game elements 712a-c. As part of operation of the game, the EGM 700 can output sound associated with one of the game elements 712a-c from a position of the game element 712a-c. For example, game element 712b may refer to a firetruck that can be displayed at a plurality of positions on the display 710 and sound associated with the firetruck can be output at a surface-integrated speaker at each position. In some examples, the sound can be adjusted based on whether the firetruck is displayed in the background or foreground. In additional or alternative embodiments, if a game element is no longer displayed on the display screen sound associated with the game element can be output by a surface-integrated speaker at a position corresponding to the virtual position of the game element. For example, if the firetruck virtually drives off the left side of the display 710, sound associated with the firetruck can be output by a surface-integrated speaker integrated into a surface to the left of the display 710.

As illustrated, the selector 740 is a finger of a user and is hovering on physical button 730b. In some embodiments, in response to the EGM 700 detecting that the selector 740 is hovering on the physical button 730b, the EGM 700 can output sound associated with game element 712b (the game element corresponding with physical button 740). In some examples, the EGM 700 outputs the sound via a surface-integrated speaker integrated into the display 710 at the position of the game element 712b. As a result, a user may get feedback regarding which of the game elements 712a-c is associated with each of the physical buttons 730a-c by outputting sound from one of the game elements 712a-c in response to the selector 740 hovering, touching, or pressing the corresponding physical button 730a-c.

In additional or alternative embodiments, in response to the EGM 700 detecting that the selector 740 is hovering on the physical button 730b, the EGM 700 can output sound (e.g., sound associated with game element 712b (the game element corresponding with physical button 740)) from a surface-integrated speaker integrated into the physical button 730b or a surface of the physical button panel 730. In some examples, this feedback can allow an EGM to notify a user as to which game element 712a-c is associated with each button and/or notify a user as to which physical button 730a-h is being hovered, touched, or pressed.

In additional or alternative embodiments, the EGM 700 can generate moving sound by outputting sound from a sequence of surface-integrated speakers. For example, sound can be output from a left portion of the physical button 730h, then a top portion of the physical button 730h, then a right portion of the physical button 730h, then a bottom portion of the physical button 730h. This can generate a “spinning” sound feature to draw a user's attention. In some examples, moving sound (e.g., spinning sound) can be used in response to a game state to emphasize that the EGM 700 is waiting on user input (e.g., an indication to spin).

In additional or alternative embodiments, the display device 710 can be a primary display, a secondary display, or an advertisement topper. In some examples, the EGM can be communicatively coupled with other EGMs or a central controller to allow the surface-integrated speakers to be used to output sound from a series of positions that correspond to different EGMs. In some examples, an advertisement topper can include displays associated with a series of EGMs or a single display that stretches across multiple EGMs. Sound can be output by a sequence of surface-integrated speakers along the advertisement topper to create a moving sound feature to attract users to play one of the EGMs.

In additional or alternative embodiments, surface-integrated speakers can be used to provide haptic feedback. In some examples, the surface-integrated speakers can be configured to generate sound at frequencies that a human can not hear but with a vibration that can be felt by a human. In additional or alternative examples, a surface-integrated speaker can be used to generate tactile feedback associated with a reel stop or coins falling during a jackpot.

In some embodiments, an EGM may use surface-integrated speakers in addition to traditional speakers. In other embodiments, an EGM may use surface-integrated speakers as a replacement for traditional speakers, which may allow an EGM to have a smaller footprint.

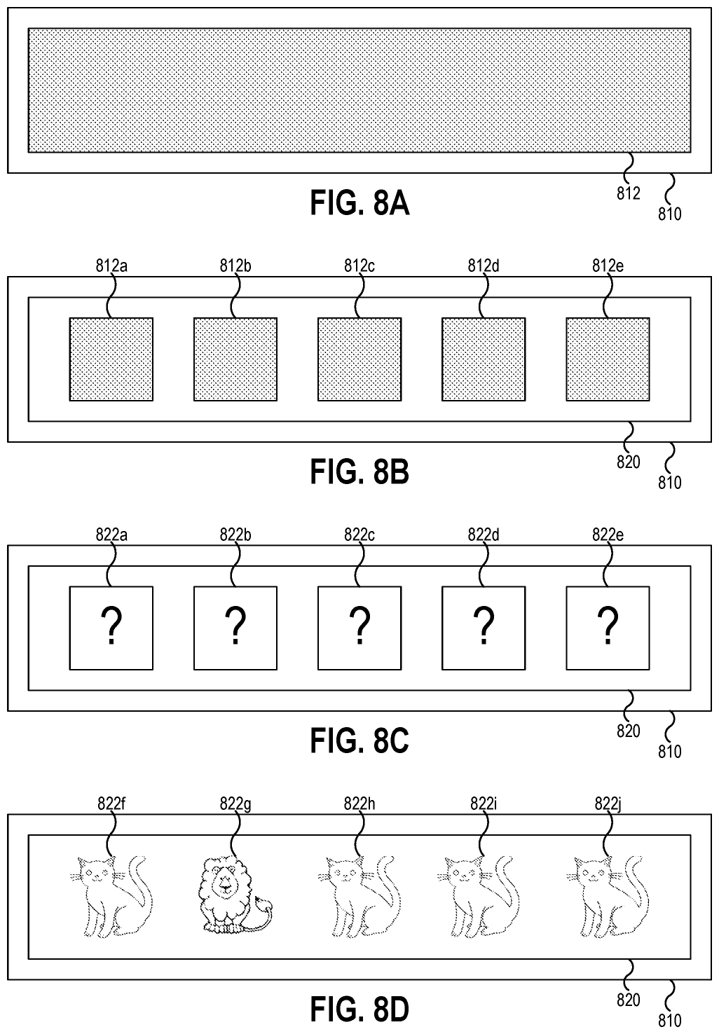

FIGS. 8A-D illustrate examples of a display 810 including a surface-integrated speaker 812 integrated into a display surface 820 that is configured to display game elements 822a-j. FIG. 8B illustrates an example in which the surface-integrated speaker 812 can include five surface-integrated speakers 812a-e that can be individually and/or simultaneously controlled. FIG. 8C illustrates an example of game elements 822a-e being displayed as mystery boxes. The game elements 822a-e are positioned on the display surface such that each game element 822a-e is positioned at a location of one of the surface-integrated speakers 812a-c. FIG. 8D illustrates an example of the game elements 822a-e being replaced by game elements 822f-j. In some embodiments, the EGM may provide a game in which sound associated with a cat (game elements 822f and 822h-j) are output by surface-integrated speakers 812a, 812c-e and sound associated with a lion (game element 822g) is output by surface-integrated speaker 812b. In some examples, these sounds are output while game elements 822a-e (the mystery boxes) are displayed (and game elements 822f-j are hidden or not displayed). By having the sound be output from surface-integrated speakers at specific positions, a user may be able to determine that the position of the lion and/or the cats.

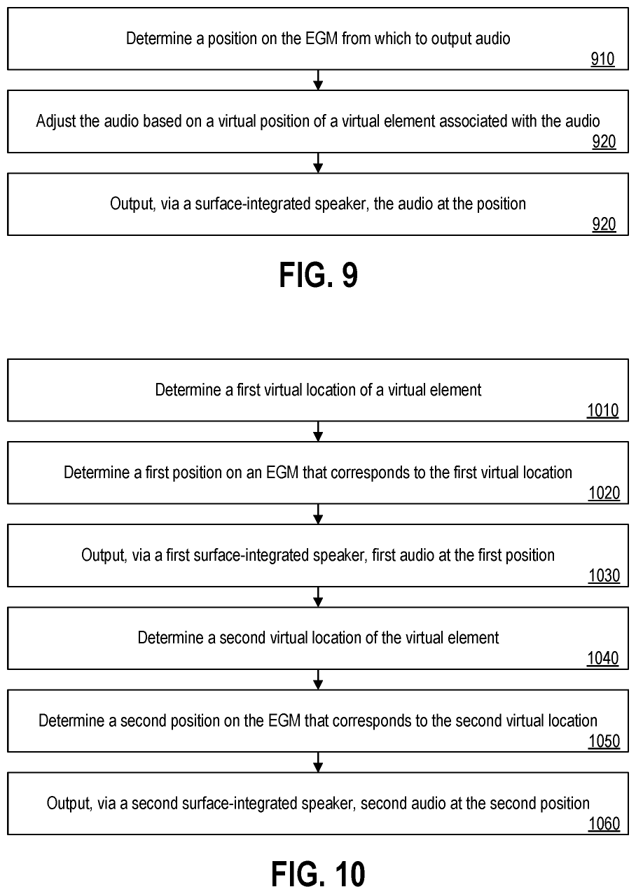

FIGS. 9-10 illustrate examples of operations performed by an EGM according to some embodiments. Although the operations will be described in regards to EGM 100 of FIG. 2B, the operations can be performed by other elements of EGM 100 and/or by any suitable EGM.

FIG. 9 illustrates an example of an operation performed by an EGM 100 including a surface-integrated speaker 150. In some embodiments, the EGM 100 includes the surface-integrated speaker 150, a processor circuit 12 communicatively coupled to the surface-integrated speaker 150, and a memory 14 coupled to the processor circuit 12. The memory 14 can include machine-readable instructions that, when executed by the processing circuit 12 cause the EGM 100 to perform the operations.

At block 910, processor circuit 12 determines a position on the EGM 100 from which to output audio. In some embodiments, the EGM includes a display device including a display device configured to display a virtual element on a display surface. In some examples, the surface-integrated speaker includes at least one of: a first plurality of speakers integrated into the display surface; and a second plurality of speakers integrated into a surface that is separate from the display surface. Determining the position on the EGM from which to output the audio includes determining the position on the EGM corresponding to a virtual location of the virtual element.

In additional or alternative embodiments, the EGM further includes an input device configured to detect user input. The surface-integrated speaker can include a speaker integrated into a surface of the input device. Determining the position on the EGM from which to output the audio can include determining to output the audio from the speaker integrated into the surface of the input device in response to at least one of: the input device detecting the user input; and a state of the EGM being associated with waiting for the user input.

In additional or alternative embodiments, the EGM further includes an input device configured to detect user input. The surface-integrated speaker can include a speaker integrated into a surface adjacent to the input device. Determining the position on the EGM from which to output the audio includes determining to output the audio from the speaker integrated into the surface adjacent to the input device in response to at least one of: the input device detecting the user input; and a state of the EGM being associated with waiting for the user input.

In additional or alternative embodiments, the EGM includes a peripheral device communicatively coupled to the processing circuit. The peripheral device includes the surface-integrated speaker. In some examples, the peripheral device includes at least one of: a seat; an armrest; a backrest; and a headset.

At block 920, processor circuit 12 adjusts the audio based on a virtual position of a virtual element associated with the audio. In some embodiments, the virtual element is a virtual game element associated with a game provided by the EGM. In some examples, the audio is adjusted based on a virtual depth of the virtual element.

At block 930, processor circuit 12 output, via a surface-integrated speaker 150, the audio at the position. In some embodiments, the audio is output from a sequence of surface-integrated speakers to generate an effect of moving sound.

In additional or alternative embodiments, the surface-integrated speaker includes a plurality of speakers integrated into the display surface. Determining the position on the EGM corresponding to the virtual location of the virtual element includes determining that the virtual location of the virtual element is associated with a position on the display surface. In some examples, outputting the audio includes outputting the audio via a speaker of the first plurality of speakers. The speaker of the first plurality of speakers can be integrated into the display surface at the position on the display surface.

In additional or alternative embodiments, the display surface is further configured to display a virtual element on the display surface while the virtual element is within a first set of virtual locations in a virtual world associated with the display surface. Determining the position on the EGM corresponding to the virtual location of the virtual element includes determining that the virtual location of the virtual element is within the second set of virtual locations. In some examples, outputting the audio includes outputting the audio via a speaker of the second plurality of speakers. The speaker of the second plurality of speakers being integrated into the surface at a position that corresponds with the virtual location of the virtual element.

In additional or alternative embodiments, outputting the audio includes outputting haptic feedback via the surface-integrated speaker.

In additional or alternative embodiments, outputting the audio at the position comprises outputting true three-dimensional (“3D”) audio.

FIG. 10 illustrates an example of an operation performed by non-transitory computer-readable medium on an EGM 100. The non-transitory computer-readable medium can include instructions stored therein that are executable by a processing circuit 12 to cause the processing circuit 12 to perform operations.

At block 1010 processing circuit 12 determines a first virtual location of a virtual element. At block 1020, processing circuit 12 determines a first position of an EGM 100 that corresponds to the first virtual location. At block 1030, processing circuit 12 outputs, via a first surface integrated speaker 150, first audio at the first position. In some embodiments, the first virtual element is a first virtual game element associated with operation of a game on the EGM being displayed on a display surface. The first position on the EGM includes a first position on the display surface. Outputting the first audio includes outputting true 3D audio via the surface-integrated speaker integrated into the display surface.

At block 1040, processing circuit 12 determines a second virtual location of the virtual element. At block 1050, processing circuit 12 determines a second position on the EGM 100 that corresponds to the second virtual location. At block 1060, processing circuit 12 outputs, via a second surface-integrated speaker 150, second audio at the second position. In some embodiments, the second virtual element is a second virtual game element associated with operation of the game on the EGM being displayed on the display surface. The second position on the EGM includes a second position on the display surface. Outputting the second audio includes outputting true 3D audio via the surface-integrated speaker integrated into the display surface.

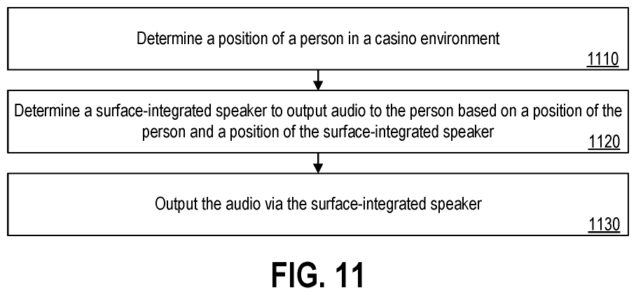

FIG. 11 illustrates an example of operations performed by a central controller according to some embodiments. Although the operations will be described in regards to central controller 40 of FIG. 1, the operations can be performed by an EGM 100 and/or any suitable device or system.

At block 1110, processing circuit 42 determines a position of a person in a casino environment. At block 1120, processing circuit 42 determines a surface-integrated speaker to output audio to the person based on a position of the person and a position of the surface-integrated speaker. In some embodiments, determining the surface-integrated speaker to output the audio to the person includes: determining a location in the casino environment to direct the person towards; and determining the surface-integrated speaker to output the audio to the person based on the position of the surface-integrated speaker being along a path between the position of the person and the location in the casino environment. In some examples, the location in the casino environment includes an available EGM. In additional or alternative examples, the audio includes an indication of the available EGM. In additional or alternative examples, the surface-integrated speaker is integrated into a surface of the available EGM. At block 1130, processing circuit 42 outputs the audio via the surface-integrated speaker.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the FIGS. illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising.” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. An electronic gaming machine (“EGM”), the EGM comprising:
a surface-integrated speaker;
a processor circuit communicatively coupled to the surface-integrated speaker; and
a memory coupled to the processor circuit, the memory comprising machine-readable instructions that, when executed by the processor circuit, cause the EGM to perform operations comprising:
determining a position on the EGM from which to output audio; and
outputting, via the surface-integrated speaker, the audio at the position.

2. The EGM of claim 1, further comprising:
a display device including a display surface configured to display a virtual element on the display surface,
wherein the surface-integrated speaker comprises at least one of:
a first plurality of speakers integrated into the display surface; and
a second plurality of speakers integrated into a surface that is separate from the display surface, and
wherein determining the position on the EGM from which to output the audio comprises determining the position on the EGM corresponding to a virtual location of the virtual element.

3. The EGM of claim 2, wherein the surface-integrated speaker comprises a plurality of speakers integrated into the display surface, and
wherein determining the position on the EGM corresponding to the virtual location of the virtual element comprises determining that the virtual location of the virtual element is associated with a position on the display surface, and
wherein outputting the audio comprises outputting the audio via a speaker of the first plurality of speakers, the speaker of the first plurality of speakers being integrated into the display surface at the position on the display surface.

4. The EGM of claim 2, wherein the display surface is further configured to display a virtual element on the display surface while the virtual element is within a first set of virtual locations in a virtual world associated with the display surface,
wherein determining the position on the EGM corresponding to the virtual location of the virtual element comprises determining that the virtual location of the virtual element is within the second set of virtual locations, and
wherein outputting the audio comprises outputting the audio via a speaker of the second plurality of speakers, the speaker of the second plurality of speakers being integrated into the surface at a position that corresponds with the virtual location of the virtual element.

5. The EGM of claim 2, wherein the virtual element is a virtual game element associated with a game provided by the EGM.

6. The EGM of claim 2, further comprising:
adjusting the audio based on the virtual location of the virtual element.

7. The EGM of claim 2, wherein the position on the EGM is a first position on the EGM, wherein the audio is first audio,
wherein the virtual location of the virtual element is a first virtual location of the virtual element,
the operations further comprising:
determining a second virtual location of the virtual element;
determining a second position on the EGM that corresponds to the second virtual location of the virtual element; and
outputting, via a second speaker, second audio at the second position, the second speaker being one of the first plurality of speakers or the second plurality of speakers.

8. The EGM of claim 1, further comprising:
an input device configured to detect user input,
wherein the surface-integrated speaker comprises a speaker integrated into a surface of the input device, and
wherein determining the position on the EGM from which to output the audio comprises determining to output the audio from the speaker integrated into the surface of the input device in response to at least one of:
the input device detecting the user input; and
a state of the EGM being associated with waiting for the user input.

9. The EGM of claim 1, further comprising:
an input device configured to detect user input,
wherein the surface-integrated speaker comprises a speaker integrated into a surface adjacent to the input device, and
wherein determining the position on the EGM from which to output the audio comprises determining to output the audio from the speaker integrated into the surface adjacent to the input device in response to at least one of:
the input device detecting the user input; and
a state of the EGM being associated with waiting for the user input.

10. The EGM of claim 1, wherein the surface-integrated speaker is a first surface-integrated speakers of a plurality of surface-integrated speakers,
wherein the position on the EGM is a first position on the EGM,
wherein the audio is first audio associated with a first time,
the operations further comprising:
determining a second position on the EGM from which to output second audio at a second time that is subsequent to the first time; and
outputting, via a second surface-integrated speaker, the second audio at the second position at the second time to generate an effect of moving sound.

11. The EGM of claim 1, further comprising:
a peripheral device communicatively coupled to the processing circuit and including the surface-integrated speaker, the peripheral device comprising at least one of:
a seat;
an armrest;
a backrest; and
a headset.

12. The EGM of claim 1, wherein outputting the audio comprises outputting haptic feedback via the surface-integrated speaker.

13. The EGM of claim 1, wherein outputting the audio at the position comprises outputting true three-dimensional (“3D”) audio.

14. A non-transitory computer-readable medium having instructions stored therein that are executable by processing circuit therein to cause the processing circuit to perform operations comprising:
determining a virtual location of a virtual element associated with operation of an electronic game machine (“EGM”);
determining an auditory output associated with the virtual element;
determining a position on the EGM corresponding to the auditory output associated with the virtual element based on the virtual location; and
outputting true three-dimensional (“3D”) audio of the auditory output via a surface-integrated speaker at the position on the EGM.

15. The non-transitory computer-readable medium of claim 14, wherein the virtual element is a virtual game element associated with operation of a game on the EGM being displayed on a display surface,
wherein the position on the EGM comprises a position on the display surface, and
wherein outputting the true 3D audio comprises outputting the auditory output via the surface-integrated speaker integrated into the display surface.

16. The non-transitory computer-readable medium of claim 14, wherein the virtual location is a first virtual location of the virtual element at a first time,
wherein the auditory output is first auditory output,
wherein the position on the EGM is a first position on the EGM, and
wherein the surface-integrated speaker is a first surface-integrated speaker,
the operations further comprising:
determining a second virtual location of the virtual element at a second time;
determining a second auditory output associated with the virtual element;
determining a second position on the EGM corresponding to the second auditory output associated with the virtual element based on the second virtual location; and
subsequent to outputting the true 3D audio of the first auditory output, indicating movement of the virtual element by outputting true 3D audio of the second auditory output via a second surface-integrated speaker at the second position on the EGM.

17. A method of operating audio in a casino environment, the method comprising:
determining a position of a person in a casino environment;
determining a surface-integrated speaker to output audio to the person based on a position of the person and a position of the surface-integrated speaker; and
outputting the audio via the surface-integrated speaker.

18. The method of claim 17, wherein determining the surface-integrated speaker to output the audio to the person comprises:
determining a location in the casino environment to direct the person towards; and
determining the surface-integrated speaker to output the audio to the person based on the position of the surface-integrated speaker being along a path between the position of the person and the location in the casino environment.

19. The method of claim 18, wherein the location in the casino environment includes an available electronic gaming machine (“EGM”), and
wherein the audio includes an indication of the available EGM.

20. The method of claim 19, wherein the surface-integrated speaker is integrated into a surface of the available EGM.
